(19) United States
(12) Patent Application Publication
(10) Pub. No.: US 2014/0154113 A1
(43) Pub. Date: Jun. 5, 2014

(54) HIGH TEMPERATURE DOWNHOLE MOTORS WITH ADVANCED POLYIMIDE INSULATION MATERIALS

(71) Applicant: GE OIL & GAS ESP, INC., Oklahoma City, OK (US)

(72) Inventors: Weijun Yin, Niskayuna, NY (US); Manoj Ramprasad Shah, Niskayuna, NY (US); Norman Arnold Turnquist, Niskayuna, NY (US); Jeremy Daniel Van Dam, Niskayuna, NY (US); Enis Tuncer, Niskayuna, NY (US); Edward John Flett, Oklahoma City, OK (US)

(73) Assignee: GE OIL & GAS ESP, INC., Oklahoma City, OK (US)

(21) Appl. No.: 13/706,322

(22) Filed: Dec. 5, 2012

(51) Int. Cl. H02K 3/30; H02K 15/10; F04B 17/03; H02K 11/00; H02K 3/34

(52) U.S. Cl. CPC H02K 3/30; H02K 11/00; H02K 3/345; F04B 17/03; H02K 15/10
USPC 417/410.1; 310/71; 310/215; 29/596

(57) ABSTRACT

An electric motor assembly configured for use in a downhole pumping system includes a number of electrically conductive components that are insulated from fluids, mechanical abrasion, electrical current and electrical grounds using an advanced polyimide film. Preferred polyimide films include poly(4,4′-oxydiphenylene-pyromellitimide) and biphenyl-tetracarboxylic acid dianhydride (BPDA) type polyimide films. Magnet wire, stator laminates, stator coil end turns, motor leads and power cables can all be insulated with the selected polyimide film.

### STATEMENT ABOUT GOVERNMENT SPONSORED RESEARCH

Portions of this invention were made with government support under government contract DE-EE0002752 awarded by the Department of Energy. The government has certain rights in the invention.

### FIELD OF THE INVENTION

This invention relates generally to the field of electric motors, and more particularly, but not by way of limitation, to improved magnet wire for use in high-temperature downhole pumping applications.

### BACKGROUND

Electrical submersible pumping systems include specialized electric motors that are used to power one or more high performance pump assemblies. The motor is typically an oil-filled, high capacity electric motor that can vary in length from a few feet to nearly fifty feet, and may be rated up to hundreds of horsepower. The electrical submersible pumping systems are often subjected to high-temperature, corrosive environments. Each component within the electrical submersible pump must be designed and manufactured to withstand these hostile conditions.

Like other electrodynamic systems, the motors used in downhole pumping systems typically include a stator and a rotor. The stator typically has a metallic core with electrically insulated wire winding through the metallic core to form the stator coil. When current is alternately passed through a series of coils, magnetic flux fields are formed, which cause the rotor to rotate in accordance with electromagnetic physics. To wind the stator coil, the wire is first threaded through the stator core in one direction, and then turned and threaded back through the stator in the opposite direction until the entire stator coil is wound. Each time the wire is turned to run back through the stator, an end turn is produced. A typical motor will have many such end turns upon completion.

In the past, motor manufacturers have used various insulating materials on the magnet wire used to wind the stator. Commonly used insulation includes polyether ether ketone (PEEK) thermoplastics and polyimide films. Insulating the conductor in the magnet wire prevents the electrical circuit from shorting or otherwise prematurely failing. The insulating material is typically extruded, solution coated or film tape wrapped onto the underlying copper conductor. In recent years, manufacturers have used insulating materials that are resistant to heat, mechanical wear and chemical exposure.

Although widely accepted, current insulation materials may be inadequate for certain high-temperature downhole applications. In particular, motors employed in downhole applications where modern steam-assisted gravity drainage (SAGD) recovery methods are employed, the motor may be subjected to elevated temperatures. Extruded insulation material often suffers from variations in thickness, eccentricity and contamination as a result of the extrusion process. Prior film-based insulation requires the use of adhesive layers between the conductor and layers of film, which often has lower temperature performance than the film. There is, therefore, a need for an improved magnet wire that exhibits enhanced resistance to heat, corrosive chemicals, mechanical wear and other aggravating factors. It is to this and other deficiencies in the prior art that the present invention is directed.

### SUMMARY OF THE INVENTION

In a preferred embodiment, the present invention provides an electric motor assembly configured for use in a downhole pumping system. The electric motor assembly includes a number of electrically conductive components that are insulated from fluids, mechanical abrasion, electrical current and electrical grounds using an advanced polyimide film. Preferred polyimide films include poly(4,4′-oxydiphenylene-pyromellitimide) and biphenyl-tetracarboxylic acid dianhydride (BPDA) type polyimide films. Magnet wire, stator laminates, stator coil end turns, motor leads and power cables can all be insulated with the selected polyimide film.

In another aspect, the present invention provides a method of manufacturing a motor assembly for use in an electrical submersible pumping system. The method includes the step of providing an insulator film selected from the group consisting of poly(4,4′-oxydiphenylene-pyromellitimide) and biphenyl-tetracarboxylic acid dianhydride (BPDA) type polyimide films, wrapping the insulator film around an electrically conducive motor component and heating the wrapped insulator film to its melting point to create a sealed, insulated electrically conductive motor component.

### BRIEF DESCRIPTION OF THE DRAWINGS

FIG. 1 is a back view of a downhole pumping system constructed in accordance with a presently preferred embodiment.

FIG. 2 is a side elevational view of the motor assembly of the pumping system of FIG. 1.

FIG. 3 is a partial cross-sectional view of the motor assembly of the pumping system of FIG. 1.

FIG. 4 is a close-up cross-sectional view of the motor assembly of the pumping system of FIG. 1.

FIG. 5 is a cross-sectional view of a piece of magnet wire from the motor of FIG. 4.

FIG. 6 is a perspective view of a round power cable from FIG. 1.

FIG. 7 is a perspective view of a flat power cable from FIG. 1.

FIG. 8 is a top plan view of a laminate from the motor assembly.

FIG. 9 is a cross-sectional view of a slot liner from the motor assembly.

FIG. 10 is a close-up partial top view of the stator core and magnet wire.

FIG. 11 is a side elevational view of the motor assembly with exposed end-turns.

### DETAILED DESCRIPTION OF THE PREFERRED EMBODIMENTS

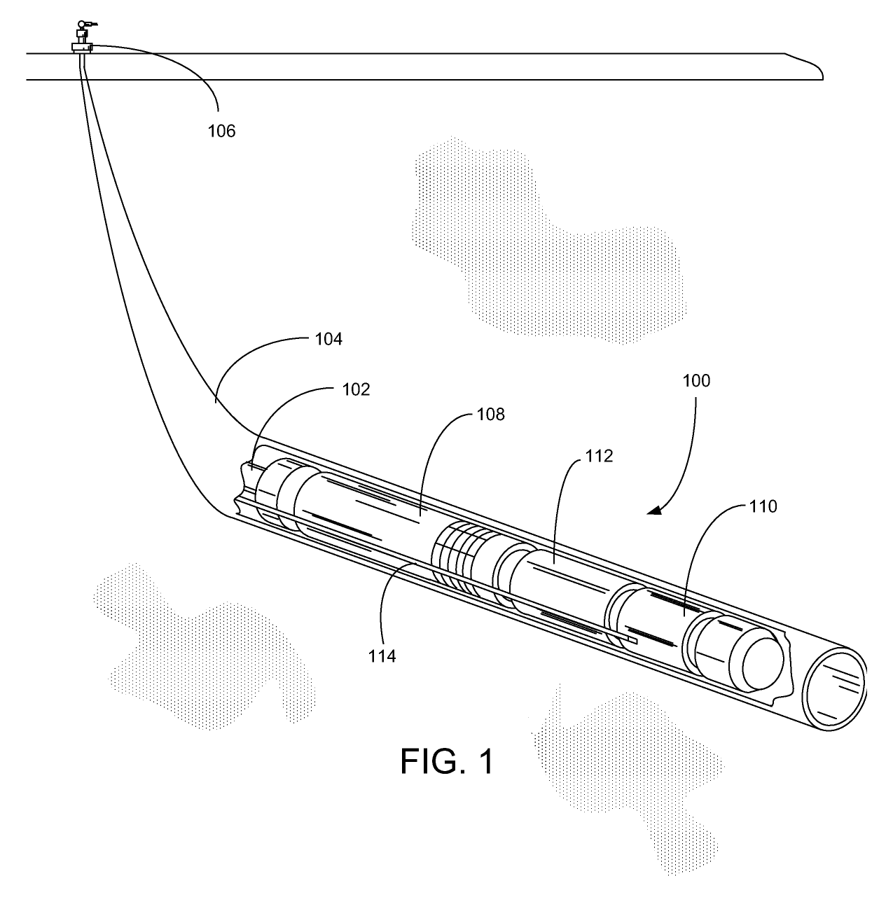

In accordance with a preferred embodiment of the present invention, FIG. 1 shows a front perspective view of a downhole pumping system 100 attached to production tubing 102. The downhole pumping system 100 and production tubing 102 are disposed in a wellbore 104, which is drilled for the production of a fluid such as water or petroleum. The downhole pumping system 100 is shown in a non-vertical well. This type of well is often referred to as a “horizontal” well. Although the downhole pumping system 100 is depicted in a horizontal well, it will be appreciated that the downhole pumping system 100 can also be used in vertical wells.

As used herein, the term “petroleum” refers broadly to all mineral hydrocarbons, such as crude oil, gas and combinations of oil and gas. The production tubing 102 connects the pumping system 100 to a wellhead 106 located on the surface. Although the pumping system 100 is primarily designed to pump petroleum products, it will be understood that the present invention can also be used to move other fluids. It will also be understood that, although each of the components of the pumping system 100 are primarily disclosed in a submersible application, some or all of these components can also be used in surface pumping operations.

The pumping system 100 preferably includes some combination of a pump assembly 108, a motor assembly 110 and a seal section 112. In a preferred embodiment, the motor assembly 110 is an electrical motor that receives its power from a surface-based supply through a power cable 114. The motor assembly 110 converts the electrical energy into mechanical energy, which is transmitted to the pump assembly 108 by one or more shafts. The pump assembly 108 then transfers a portion of this mechanical energy to fluids within the wellbore, causing the wellbore fluids to move through the production tubing to the surface. In a particularly preferred embodiment, the pump assembly 108 is a turbomachine that uses one or more impellers and diffusers to convert mechanical energy into pressure head. In an alternative embodiment, the pump assembly 108 is a progressive cavity (PC) or positive displacement pump that moves wellbore fluids with one or more screws or pistons.

The seal section 112 shields the motor assembly 110 from mechanical thrust produced by the pump assembly 108. The seal section 112 is also preferably configured to prevent the introduction of contaminants from the wellbore 104 into the motor assembly 110. Although only one pump assembly 108, seal section 112 and motor assembly 110 are shown, it will be understood that the downhole pumping system 100 could include additional pumps assemblies 108, seals sections 112 or motor assemblies 110.

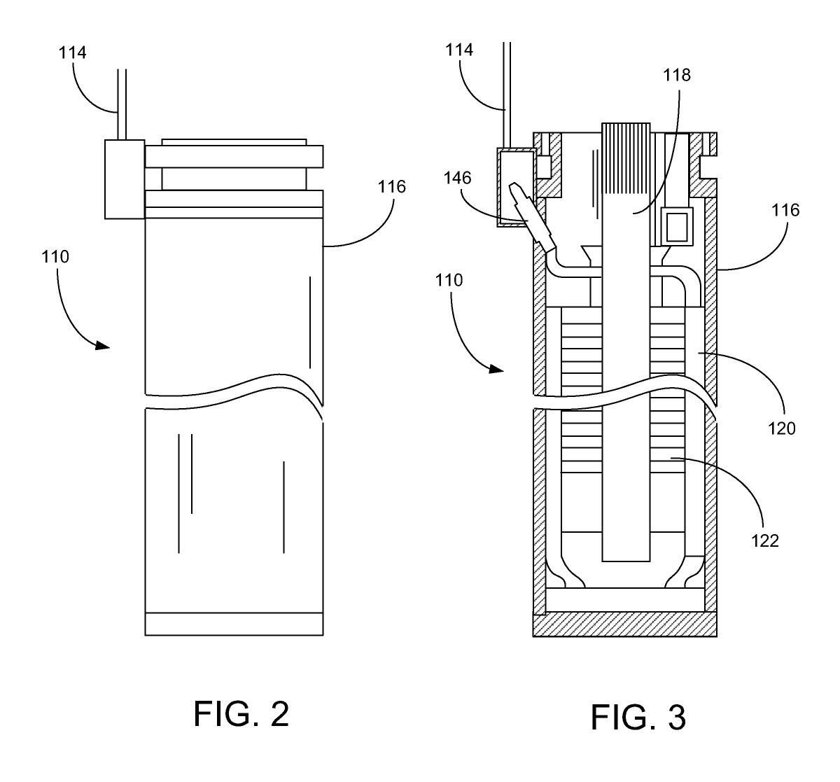

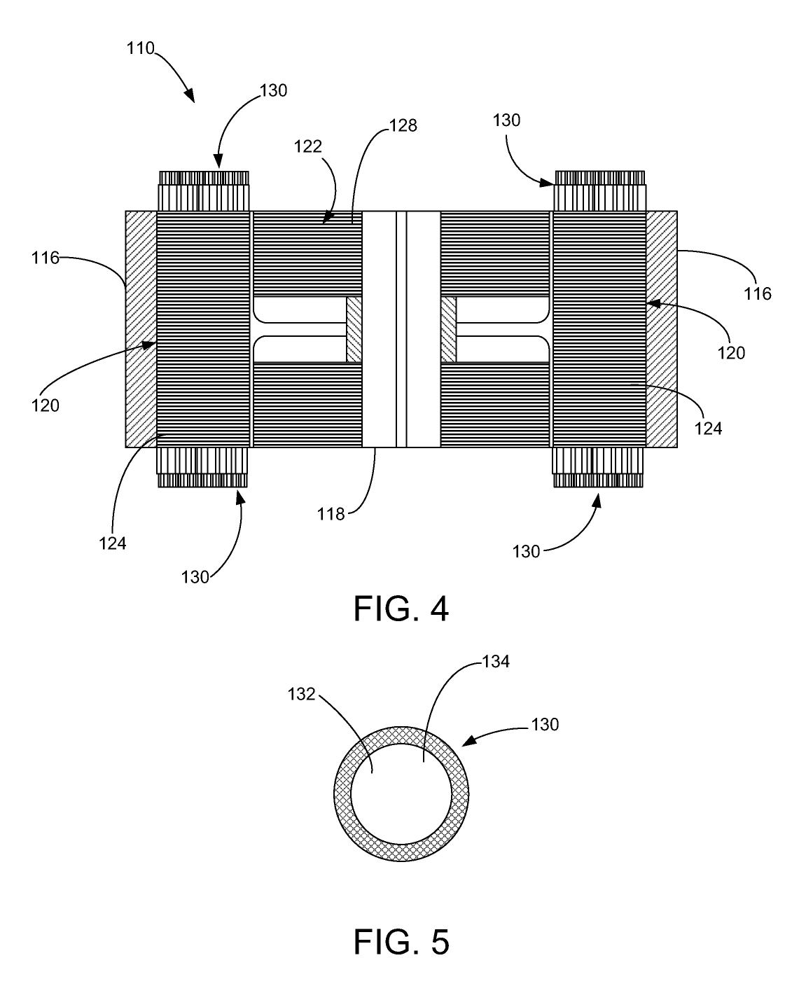

Referring now to FIGS. 2 and 3, shown therein are elevational and partial cross-section views, respectively, of the motor assembly 110. The motor assembly 110 includes a motor housing 116, a shaft 118, a stator assembly 120, and a rotor 122. The motor housing 116 encompasses and protects the internal portions of the motor assembly 110 and is preferably sealed to reduce the entry of wellbore fluids into the motor assembly 110. Referring now also to the partial cross-sectional view of the motor assembly 110 in FIG. 4, adjacent the interior surface of the motor housing 116 is the stationary stator assembly 120 that remains fixed relative the motor housing 116. The stator assembly 120 surrounds the interior rotor 122, and includes stator coils 124 extending through a stator core 126. The stator core 126 is formed by stacking and pressing a number of thin laminates 128 to create an effectively solid stator core 126. The stator coils 124 are formed by extending magnet wire 130 through the stator core 126, as depicted in FIG. 4.

FIG. 5 presents a cross-sectional view of the magnet wire 130. The magnet wire 130 preferably includes a conductor 132 and an insulator 134. The conductor 132 is preferably constructed from fully annealed, electrolytically refined copper. In an alternative embodiment, the conductor 132 is manufactured from aluminum. Although solid-core conductors 130 are presently preferred, the present invention also contemplates the use of braided or twisted conductors 130. It will be noted that the ratio of the size of the conductor 132 to the insulator 134 is for illustrative purposes only and the thickness of the insulator 134 relative to the diameter of the conductor 132 can be varied depending on the particular application.

In a first preferred embodiment, the insulator 134 is a heat-bonding type polyimide film. In a particularly preferred embodiment, the heat-bonding type polyimide film is biphenyl-tetracarboxylic acid dianhydride (BPDA) type polyimide film where the thermoset polyimide film is coated with thermal plastic polyimide. The thermal plastic polyimide melt flows at temperature above 300 C that permits heat bonding without the use of an intervening adhesive layer which usually melts below 300 C. Thus increasing the thermal capability of the insulation. Suitable polyimide films are available from UBE Industries, Ltd. under the “UPILEX VT” line of products. The polyimide insulator 134 can be heat laminated directly to the conductor 132 without the use of an adhesive. In this first preferred embodiment, the heat-bonding type polyimide film insulator 134 may be used in combination with fluoropolymer film and PEEK film, e.g., the conductor 132 is film wrapped with polyimide film, heat fused then wrapped with PEEK film or fluoropolymer films such as polytetrafluoroethylene (PTFE) film. The PTFE film is preferably to be calendared, sintered and etched for better adhesion. In particularly preferred embodiments, the PEEK film is a biaxially stretched film that has a higher modulus.

The process for laminating the BPDA type polyimide film directly to the conductor 132 preferably includes the step of heating the conductor 132 and insulator 134 to above about 300° C. To prevent the oxidation of the conductor 132 under these temperatures, the conductor 132 can be nickel-plated. Alternatively, the heat bonding process can be carried out in an inert gas atmosphere to prevent oxidation of the conductor 132. The use of BPDA type polyimide film for the insulator 134 permits the use of the magnet wire 130 above about 250° C.

In a second preferred embodiment, the insulator 134 is manufactured from a water-resistant polyimide film, such as poly(4,4′-oxydiphenylene-pyromellitimide). Suitable water-resistant polyimide films are available from E.I. du Pont de Nemours and Company under the KAPTON WR line of products and from UBE Industries, Ltd. under the UPILEX S line of products. These films provide an insulator 134 with significantly increased resistance to hydrolysis. In this second preferred embodiment, the water-resistant polyimide film insulator 134 may be used in combination with a fluoropolymer films and PEEK film, e.g., the conductor 132 is film wrapped with polyimide film, heat fused then wrapped with PEEK film or fluoropolymer films such as PTFE film. The PTFE film is preferably to be calendared, sintered and etched for better adhesion. In particularly preferred embodiments, the PEEK film is a biaxially stretched film that has a higher modulus.

In the preferred embodiments, the selected insulator 134 is wrapped around the conductor 132. In particularly preferred embodiments, two or more layers of the insulator 134 film are wrapped around the conductor 132. It will be appreciated to those of skill in the art that alternative methods of wrapping the insulator 134 around the conductor 132 are within the scope of the present invention.

The use of a melt-processable film insulator 134 permits the omission of an adhesive between the insulator 134 and conductor 132. In presently preferred embodiments, the insulator 134 is directly applied to the conductor 132 and then sealed through application of heat to the insulator 134. In a particularly preferred embodiment, the insulator 134 is wrapped around the conductor 132 and then heated to the polymer melt point. Pressure is then applied to bring the molten polymer insulator 134 into full contact with the conductor 132. Heat and pressure can be applied through the combined use of heated anvils or rollers, ultrasonic equipment or lasers.

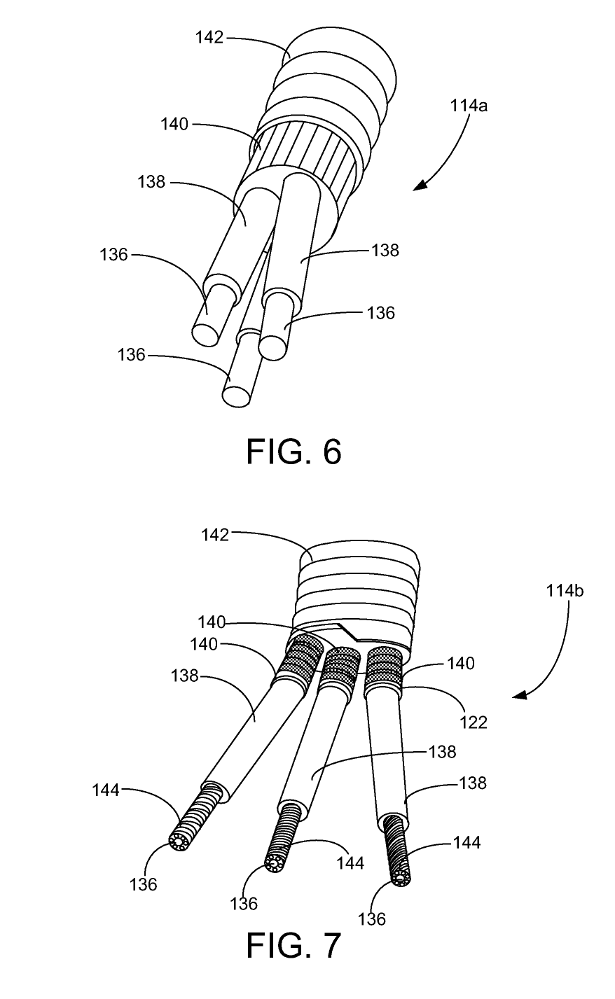

Turning to FIGS. 6 and 7, shown therein are perspective views of a round power cable 114a and a flat power cable 114b, respectively. It will be understood that the geometric configuration of the power cable 114 can be selected on an application specific basis. Generally, flat power cables, as shown in FIG. 6, are preferred in applications where there is a limited amount of space around the pumping system 100 in the wellbore 104. As used herein, the term “power cable 114” collectively refers to the round power cable 114a and the flat power cable 114b. In the presently preferred embodiment, the power cable 114 includes power cable conductors 136, power cable insulators 138, a jacket 140 and external armor 142.

The power cable conductors 136 are preferably manufactured from copper wire or other suitable metal. The power cable conductors 136 can include a solid core (as shown in FIG. 2), a stranded core or a stranded exterior 144 surrounding a solid core (as shown in FIG. 3). The power cable conductors 136 can also by coated with one or more layers of tin, nickel, silver, polyimide film or other suitable material. It will be understood that the size, design and composition of the power cable conductors 136 can vary depending on the requirements of the particular downhole application.

The power cable insulators 138 preferably include at least one layer of a heat-bonding type polyimide film. In a particularly preferred embodiment, the power cable insulators 138 are manufactured from a biphenyl-tetracarboxylic acid dianhydride (BPDA) type polyimide film that permits heat bonding without the use of an intervening adhesive layer. Suitable polyimide films are available from UBE Industries, Ltd. under the “UPILEX VT” line of products. The polyimide film power cable insulator 138 can be heat laminated directly to the conductor 136 without the use of an adhesive. The power cable insulators 138 are preferably encased within the jacket 140. In the preferred embodiment, the jacket 140 is constructed one or more layers of lead, nitrile, EPDM or thermoplastic, or some combination of these materials. As shown in FIG. 3, the jacket 140 can be wrapped with a braid or bedding tape 128. The tape 128 offers an additional protective barrier to the jacket 140, power cable insulators 138 and power cable conductors 136. The tape 128 can be constructed from polyvinylidene flouride (PCDF), Tedlar tape, Teflon tape or lead. The jacket 140 is protected from external contact by the armor 124. In the preferred embodiment, the armor is manufactured from galvanized steel, stainless steel, Monel or other suitable metal or composite. The armor 124 can be configured in flat and round profiles in accordance with the flat or round power cable configuration.

Although the use of BPDA type polyimide film for the insulator 134 are disclosed herein with reference to the multi-conductor power cables 114, it is also within the scope of the present invention to use BPDA type polyimide film in the motor lead cable 146 (shown in FIG. 3). In the motor lead cable 146, BPDA type polyimide film is preferably used to insulate the multiple conductors between the power cable 114 and the motor assembly 110. The present invention also contemplates the use of BPDA type polyimide film insulation to protect the connections or splices between adjacent conductors and conductors and motor leads.

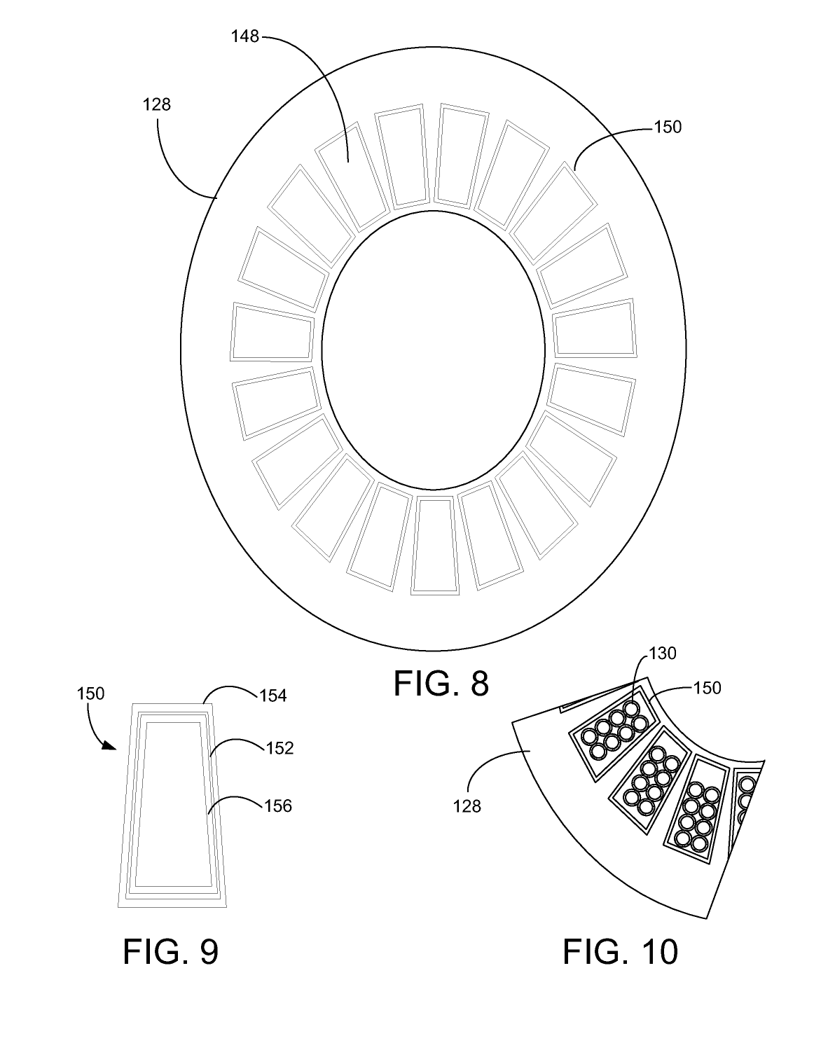

Turning to FIG. 8, shown therein is a stator laminate 128 that includes a plurality of stator slots 148 and slot liners 150. In a first preferred embodiment, the slot liner 150 is manufactured from a water-resistant polyimide film, such as poly(4,4′-oxydiphenylene-pyromellitimide). Suitable polyimide films are available from E.I. du Pont de Nemours and Company under the KAPTON WR line of products and from UBE Industries, Ltd. under the UPILEX S line of products. These films provide a slot liner with significantly increased resistance to hydrolysis.

Referring now also to FIG. 9, shown therein is a cross-sectional view of the slot liner 150 constructed in accordance with a second preferred embodiment. The slot liner 150 is constructed of a polymeric film 152 sandwiched between first fabric 154 and a second fabric 156. The first and second fabric layers 154, 156 are preferably either woven ceramic fabric or glass fabric, or both woven ceramic and glass fabric. The first and second fabric layers 154, 156 provide physical spacing around the polymeric film layer 152 and a porous structure that allows dielectric fluid to flow or permeate through the slots 145 for better heat dissipation.

The polymeric film 152 layer provides high dielectric strength and high thermal stability in the dielectric fluid. The polymeric film 152 layer is preferably manufactured from a polyimide film, such as UPILEX S, UPILEX VT, Kapton-E, Kapton WR Kapton PRN, and Kapton CR, which are available from UBE Industries, Ltd. and E.I. du Pont de Nemours and Company, as discussed above. Alternatively, the polymeric film 152 can be manufactured from a fluoropolymer film, such as perfluoroalkoxy polymer (PFA), sintered PTFE, super PTFE or polyetheretherketone (PEEK) film. Suitable PEEK films are available from the Victrex Company under the APTIV brands. The polymeric film 152 can also be a combination of polyimide film and PEEK film as well as polyimide film and PTFE films, e.g., the lamination of polyimide film and PEEK film or fluoropolymer films, where polyimide is sandwiched by either PEEK or fluoropolymer films.

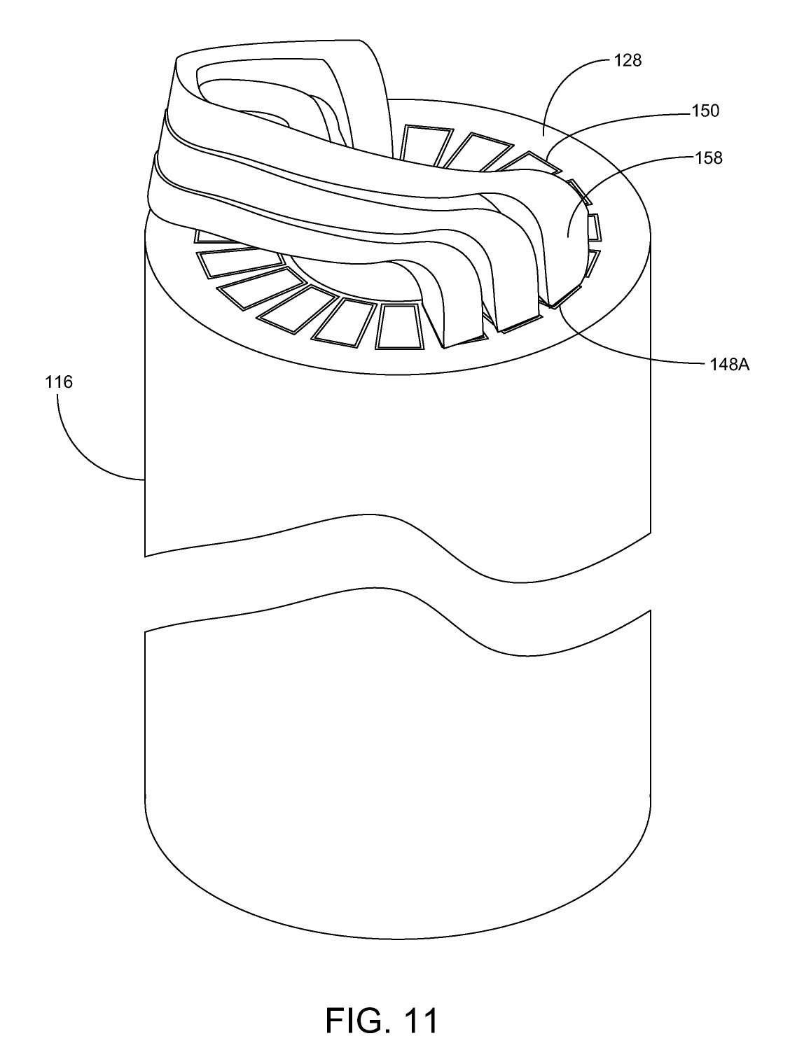

As illustrated in FIG. 10, each stator coil 124 is preferably created by winding a magnet wire 130 back and forth though the slot liners 150 in the slots 148 in the stator core 126. The magnet wire 130 is insulated from the laminates 128 by the slot liners 150. Each time the magnet wire 130 is turned 180° to be threaded back through an opposing slot, an end turn 158 is produced, which extends beyond the length of the stator core 126, as illustrated in FIG. 11. It will be noted that FIG. 10 provides an illustration of multiple passes of the magnet wires 130. The coils of magnet wire 130 are terminated and connected to a power source using one of several wiring configurations known in the art, such as a wye or delta configurations.

Turning to FIG. 11, shown therein is a depiction of several end turns 158. In the preferred embodiment, a first stator coil 124A is wound by first passing magnet wire 130 in one direction through the length of slot 148A. When the wire 130 has reached the end of the stator core 126, the wire 130 is turned 180° and passed through the length of slot 148A′ (not visible in FIG. 11) in the opposite direction, thereby creating an end turn 158. When the wire 130 has been pulled through slot 148A′ the length of stator core 126, it is again turned 180° and passed back through slot 148A. This process is repeated until slots 148A and 148A′ have been filled to a desired extent by subsequent passes of the magnet wire 130. Each of the end turns 158 is preferably insulated with a water-resistant polyimide film. Suitable polyimide films are available from E.I. du Pont de Nemours and Company under the KAPTON WR line of products and from UBE Industries, Ltd. under the UPILEX S line of products. These films provide the end turn 158 with significantly increased resistance to hydrolysis.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. An electric motor assembly configured for use in a downhole pumping system, wherein the motor assembly comprises a plurality of electrically conductive motor components, wherein at least one of the plurality of electrically conductive motor components comprises:
a conductor; and
an insulator selected from the group consisting of poly(4,4′-oxydiphenylene-pyromellitimide) and biphenyl-tetracarboxylic acid dianhydride (BPDA) type polyimide films.

2. The electric motor assembly of claim 1, wherein the polyimide film is applied directly to the conductor without the use of an intervening adhesive.

3. The electric motor assembly of claim 1, wherein the polyimide film is poly(4,4′-oxydiphenylene-pyromellitimide).

4. The electric motor assembly of claim 1, wherein the polyimide film is biphenyl-tetracarboxylic acid dianhydride (BPDA).

5. The electric motor assembly of claim 1, wherein the at least one of the plurality of electrically conductive motor components is selected from the group consisting of magnet wire, motor leads, power cables and stator coil end turns.

6. The electric motor assembly of claim 5, wherein the at least one of the plurality of electrically conductive motor components is a power cable, wherein the power cable includes:
a conductor;
a power cable insulator, wherein the power cable insulator is a polyimide film selected from the group consisting of a biphenyl-tetracarboxylic acid dianhydride (BPDA) and poly(4,4′-oxydiphenylene-pyromellitimide) type films;
a jacket surrounding the conductor and insulator; and
external armor surrounding the jacket.

7. The electric motor assembly of claim 1, wherein at least one of the plurality electrically conductive motor components comprises plurality of stacked laminates, wherein each of the stacked laminates includes one or more slots, and within each of the one or more slots, the electric motor assembly includes a slot liner that includes a polyimide film selected from the group consisting of poly(4,4′-oxydiphenylene-pyromellitimide) and biphenyl-tetracarboxylic acid dianhydride (BPDA) type polyimide films.

8. The electric motor assembly of claim 7, wherein the slot liner further comprises a first fabric layer, a second fabric layer, and a polyimide film layer between the first and second fabric layers, wherein the polyimide film layer includes a polyimide film selected from the group consisting of poly(4,4′-oxydiphenylene-pyromellitimide) and biphenyl-tetracarboxylic acid dianhydride (BPDA) type polyimide films.

9. The electric motor assembly of claim 8, wherein the first fabric layer is manufactured from a material selected from the group consisting of woven ceramic fabric and glass fabric.

10. The electric motor assembly of claim 8, wherein the second fabric layer is manufactured from a material selected from the group consisting of woven ceramic fabric and glass fabric.

11. The electric motor assembly of claim 8, wherein the polyimide film is sandwiched by films selected from the group consisting of PEEK films, fluoropolymer films, laminated PTFE films and coated PTFE films.

12. An electrical submersible pumping system configured for operation in high-temperature applications, the electrical submersible pumping system comprising:
a pump assembly; and
a motor assembly connected to pump assembly, wherein the motor assembly includes a plurality of stacked laminates, wherein each of the stacked laminates includes a plurality of slots, and within one or more of the plurality of slots, the motor assembly includes a slot liner that includes a polyimide film selected from the group consisting of poly(4,4′-oxydiphenylene-pyromellitimide) and biphenyl-tetracarboxylic acid dianhydride (BPDA) type polyimide films.

13. The electrical submersible pumping system of claim 12, wherein the slot liner further comprises a first layer, a second layer, and a polyimide film layer between the first and second layers, wherein the polyimide film layer includes a polyimide film selected from the group consisting of poly(4,4′-oxydiphenylene-pyromellitimide) and biphenyl-tetracarboxylic acid dianhydride (BPDA) type polyimide films.

14. The electrical submersible pumping system of claim 13, wherein the first layer is manufactured from a material selected from the group consisting of woven ceramic fabric and glass fabric.

15. The electrical submersible pumping system of claim 14, wherein the second layer is manufactured from a material selected from the group consisting of woven ceramic fabric and glass fabric.

16. The electrical submersible pumping system of claim 13, wherein the first layer is manufactured from a material selected from the group consisting of fluoropolymers and polyetheretherketones.

17. The electrical submersible pumping system of claim 16, wherein the second layer is manufactured from a material selected from the group consisting of fluoropolymers and polyetheretherketones.

18. The electrical submersible pumping system of claim 12, wherein the motor assembly comprises a plurality of stator coils, and wherein at least one of the plurality of stator coils comprises magnet wire having an insulator surrounding a conductor, wherein the insulator is manufactured from a polyimide film selected from the group consisting of poly(4,4′-oxydiphenylene-pyromellitimide) and biphenyl-tetracarboxylic acid dianhydride (BPDA) type polyimide films.

19. A method of manufacturing a motor assembly for use in an electrical submersible pumping system, wherein the motor assembly includes a stator and a rotor, the method of manufacturing comprising the steps of:
providing an insulator film selected from the group consisting of poly(4,4′-oxydiphenylene-pyromellitimide) and biphenyl-tetracarboxylic acid dianhydride (BPDA) type polyimide films;
wrapping the insulator film around an electrical conductor to form magnet wire;
heating the magnet wire to the melting point of the insulator film; and
placing the magnet wire through the stator to produce motor windings.

20. The method of claim 19, further comprising the steps of:
forming a stator core by compressing a plurality of laminates, wherein each of the plurality of laminates includes a plurality of stator slots; and
inserting a slot liner into one or more of the plurality of stator slots, wherein the slot liner is manufactured from a film selected from the group consisting of poly(4,4′-oxydiphenylene-pyromellitimide) and biphenyl-tetracarboxylic acid dianhydride (BPDA) type polyimide films.

21. The method of claim 19, further comprising the step of:
forming a stator core by compressing a plurality of laminates, wherein each of the plurality of laminates includes a plurality of stator slots;
preparing a multilayer slot liner by securing a polyimide film layer between first and second fabric layers, wherein the polyimide film layer includes a polyimide film selected from the group consisting of poly(4,4′-oxydiphenylene-pyromellitimide) and biphenyl-tetracarboxylic acid dianhydride (BPDA) type polyimide films; and
inserting the multilayer slot liner into one or more of the plurality of stator slots, wherein the slot liner is manufactured from a film selected from the group consisting of poly(4,4′-oxydiphenylene-pyromellitimide) and biphenyl-tetracarboxylic acid dianhydride (BPDA) type polyimide films.

22. The method of claim 19, further comprising the steps of:
creating end turns by making successive stator coils; and
wrapping the end turns in a polyimide film selected from the group consisting of poly(4,4′-oxydiphenylene-pyromellitimide) and biphenyl-tetracarboxylic acid dianhydride (BPDA) type polyimide films.

23. The method of claim 22, further comprising the step of heating the wrapped end turns to prepare a sealed end turn.

24. An electric motor assembly configured for use in a downhole pumping system, wherein the motor assembly comprises:
a plurality of electrically conductive motor components, wherein at least one of the plurality of electrically conductive motor components comprises:
a conductor; and
an insulator, wherein the insulator comprises:
a polyimide film, wherein the polyimide is selected from the group consisting of poly(4,4′-oxydiphenylene-pyromellitimide) and biphenyl-tetracarboxylic acid dianhydride (BPDA) type polyimide films; and
a second insulating film.

25. The electric motor of claim 24, wherein the second insulating film is selected from the group consisting of polyether ether ketone (PEEK) film and polytetrafluoroethylene (PTFE) film.

26. The electric motor assembly of claim 25, wherein the polyimide film is applied directly to the conductor and the second insulating film is applied on top of the polyimide film by heat fusing without adhesive.

27. The electric motor assembly of claim 25, wherein the second insulating film is applied directly to the conductor and the polyimide film is applied on top of the second insulating film by heat fusing without adhesive.

28. The electric motor assembly of claim 25, wherein the polyimide film is poly(4,4′-oxydiphenylene-pyromellitimide) and the PEEK film is made of biaxially stretched semicrystalline polyetheretherketone film.

29. The electric motor assembly of claim 25, wherein the polyimide film is biphenyl-tetracarboxylic acid dianhydride (BPDA).

30. The electric motor assembly of claim 25, wherein the polyimide film is poly(4,4′-oxydiphenylene-pyromellitimide) and the fluoropolymer film is made of calendared, sintered and etched PTFE film.

31. The electric motor assembly of claim 25, wherein the at least one of the plurality of electrically conductive motor components is selected from the group consisting of magnet wire, motor leads, power cables and stator coil end turns.
